(19) United States
(12) Patent Application Publication
(10) Pub. No.: US 2022/0129637 A1
(43) Pub. Date: Apr. 28, 2022

(54) COMPUTERIZED SELECTION OF SEMANTIC FRAME ELEMENTS FROM TEXTUAL TASK DESCRIPTIONS

(71) Applicant: International Business Machines Corporation, Armonk, NY (US)

(72) Inventors: Ryosuke Kohita, Tokyo (JP); Akifumi Wachi, Tokyo (JP); Daiki Kimura, Tokyo (JP)

(21) Appl. No.: 17/078,221

(22) Filed: Oct. 23, 2020

(51) Int. Cl. G06F 40/30; G06F 16/33; G06N 3/08; G06F 40/211

(52) U.S. Cl. CPC G06F 40/30; G06F 16/3344; G06F 40/211; G06N 3/08; G06F 16/3346

(57) ABSTRACT

A computer identifies, within a task description, words that correspond to semantic element labels for the task. The computer receives, from a task source operatively connected with the computer, a textual description of a task. The computer receives semantic element labels, element identification rules, and at least one reference sentence showing natural language semantic element label use. The computer parses the description to generate words for the semantic element label to generate, a Rule Match Values based on the element identification rules for the parsed words. The computer collects words having RMVs above a threshold into sets of associated of candidate words and generates, using a neural network trained on the reference sentence, Match Likelihood Values (MLVs) indicating whether the candidate words represent a semantic element label with which the candidate word is associated. The computer selects to represent the semantic element, the associated candidate word having a highest MLV.

### BACKGROUND

The present invention relates generally to the field of Natural Language Processing (NLP), and more specifically, to computerized systems that facilitate performance of tasks by autonomous agents.

In some settings, autonomous agents are able to carry out operations when provided with details of the desired operation. In some cases, as a matter of user convenience, the details are provided in a set of instructions that contain a description of the task to be performed. If the instructions are provided in natural language or other unstructured format, it can be difficult to identify the task to be performed and the various conditions which must be satisfied for successful task completion. Although Artificial Intelligence (AI) tools exist to help analyze natural language, the wide range of terminology available to describe a given task can make accurately identifying key terms in a provided task description difficult. Over time, as the capabilities of autonomous agents increases, more and more tasks and available outcomes must be considered when analyzing provided directions. The process of identifying task requirements for use by autonomous agents within a natural language based task description is difficult and grows more complex as autonomous agent capabilities increase.

### SUMMARY

According to one embodiment, a computer-implemented method to identify, within a description of a task, words that correspond to semantic element labels associated with aspects of the task, includes receiving, by a computer, from a task source operatively connected with the computer, a textual description of a task. The computer receives from a task attribute database, semantic element labels associated with aspects of the task, metadata including element identification rules associated with the semantic element label, and at least one reference sentence showing the semantic element label used in natural language. The computer parses with a word parser, the textual description to generate a list of words. The computer determines for the semantic element label, a Rule Match Value (RMV) for each parsed word based, at least in part, on applying the element identification rules to the parsed words. The computer collects, for the semantic element label, words having RMVs that exceed a predetermined candidate match threshold into sets of associated of candidate words. The computer generates, for each candidate word, using a neural network trained on the reference sentence, Match Likelihood Values (MLVs) indicating a probability that the candidate words represent a semantic element label with which the candidate word is associated. The computer selects as the word that represents the semantic element, the associated candidate word having the highest MLV. According to aspects of the invention, the task attribute database is lexical database. According to aspects of the invention, the metadata includes a target word associated with the semantic element; and the description rule is based at least in part on the key word. According to aspects of the invention, the parsing generates a constituency-based tree from the description; and wherein the element identification rules are constituency tree-based. According to aspects of the invention, the parsing generates syntactic patterns selected from a list consisting of phrase structure patterns and dependency relation patterns; and wherein the element identification rules are based at least in part on the syntactic patterns. According to aspects of the invention, the reference sentence further includes character span annotation for the semantic element. According to aspects of the invention, the generation of the MLVs includes generating an n-dimensional vector using a transformer based encoder and scoring the n-dimensional vector using the neural network. According to aspects of the invention, the neural network is a text classifier.

According to another embodiment, a system to identify, within a description of a task, words that correspond to semantic element labels associated with aspects of the task, which comprises:

a computer system comprising a computer readable storage medium having program instructions embodied therewith, the program instructions executable by a computer to cause the computer to: receive, from a task source operatively connected with the computer, a textual description of a task; receive, from a task attribute database, at least one semantic element label associated with an aspect of the task, metadata including element identification rules associated with the at least one semantic element label, and at least one reference sentence showing the at least one semantic element label used in natural language; parse with a word parser, said textual description to generate a list of words; determine for the at least one semantic element label, a Rule Match Value (RMV) for each of said words based, at least in part, on applying the element identification rules for the at least one semantic element label to said words; collect, by said computer, for the at least one semantic element label, words having RMVs that exceed a predetermined candidate match threshold into sets of associated of candidate words; generate, by said computer, for each candidate word, using a neural network trained on said at least one reference sentence, Match Likelihood Values (MLVs) indicating a probability that each candidate word represents the at least one semantic element label with which the candidate word is associated; select as the word that represents the at least one semantic element, the associated candidate word having the highest MLV.

According to another embodiment, a computer program product to identify, within a description of a task, words that correspond to semantic element labels associated with aspects of the task, the computer program product comprising a computer readable storage medium having program instructions embodied therewith, the program instructions executable by a computer to cause the computer to: receive, using said computer, from a task source operatively connected with said computer, a textual description of a task; receive, using said computer, from a task attribute database, at least one semantic element label associated with an aspect of the task, metadata including element identification rules associated with the at least one semantic element label, and at least one reference sentence showing the at least one semantic element label used in natural language; parse, using said computer, with a word parser, said textual description to generate a list of words; determine, using said computer, for the at least one semantic element label, a Rule Match Value (RMV) for each of said words based, at least in part, on applying the element identification rules for the at least one semantic element label to said words; collect, using said computer, for the at least one semantic element label, words having RMVs that exceed a predetermined candidate match threshold into sets of associated of candidate words; generate, for each candidate word, using a neural network trained on said at least one reference sentence, Match Likelihood Values (MLVs) indicating a probability that each candidate word represents the at least one semantic element label with which the candidate word is associated; select, using said computer, as the word that represents the at least one semantic element, the associated candidate word having the highest MLV.

The present disclosure recognizes the shortcomings and problems associated with using known AI techniques to extract task attributes from provided directions. According to aspects of the invention, identifying words in descriptions for categorized tasks that facilitate performance of the task by an autonomous agent is improved through the strategic use of complementary techniques. According to aspects of the invention, rule-based filters are used to quickly filter and generate groups of candidate words that might provide various conditions to be met for successful task completion by an autonomous agent. According to aspects of the invention, using a fine-tuned neural network or similar ranking model to score the filtered groups of candidate words provides improved accuracy beyond mere rule-based assessments, while reducing the amount of computing time required to provide the increased accuracy. By eliminating from consideration words that do not meet quickly-applied rules and then applying computing intensive routines on the remaining words, aspects of the present invention use complementary tools to provide a high degree of accuracy while increasing overall processing efficiency.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for computer-implemented identification of words in descriptions for a categorized task that correspond to elements needed to that facilitate performance of the task by an autonomous agent according to embodiments of the present invention.

FIG. 2 is a flowchart illustrating a method, implemented using the system shown in FIG. 1, of identifying words in descriptions for categorized tasks that facilitate performance of the task by an autonomous agent according to aspects of the invention.

FIG. 3 is a table showing an exemplary description of a task to be accomplished and selected aspects of the task according to aspects of the invention.

FIG. 4 is a table showing selected information about element labels associated with the task described in FIG. 3, according to aspects of the invention.

FIG. 5 is a table providing selected exemplary Natural Language use of the element labels shown in FIG. 4, according to aspects of the invention.

FIG. 6 is a constituency tree representing the task description shown in FIG. 3, according to aspects of the invention.

FIG. 7 is a table showing rule-base relevance of candidate words from the description shown in FIG. 3 to the element labels shown in FIG. 4, according to aspects of the invention.

FIG. 8 is a table showing exemplary rule-based relevance of words from the description shown in FIG. 3 to the element labels shown in FIG. 4, according to aspects of the invention.

FIG. 9 is a table showing words selected from the task description shown in FIG. 3 to provide task details corresponding to the element labels shown in FIG. 4, according to aspects of the invention.

FIG. 10 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 11 depicts a cloud computing environment according to an embodiment of the present invention.

FIG. 12 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

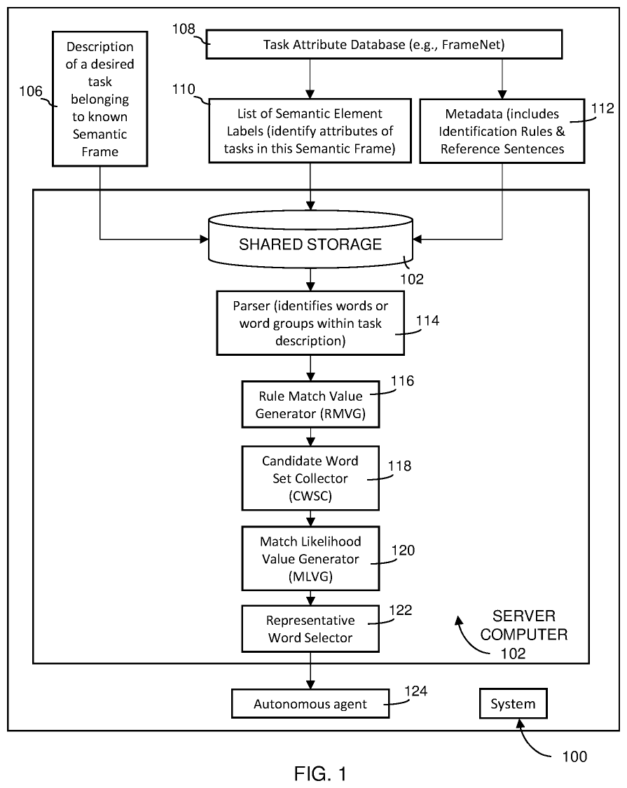

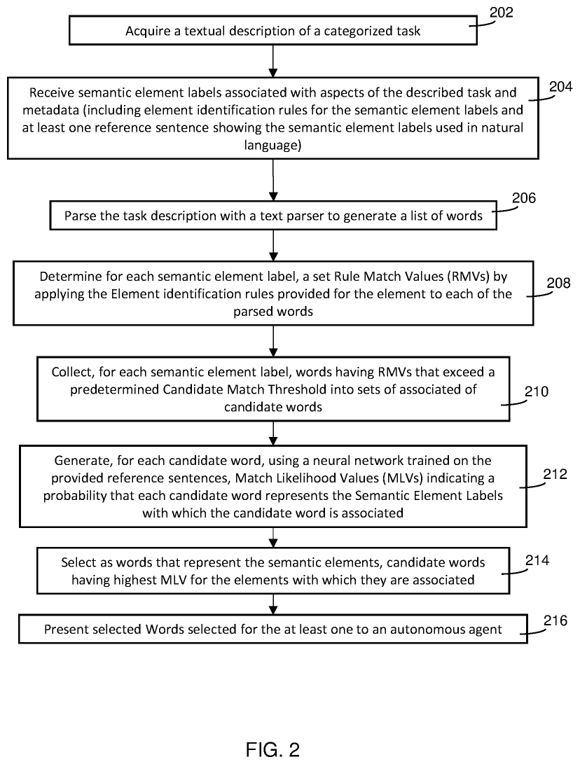

Now with combined reference to the Figures generally and with particular reference to FIG. 1 and FIG. 2, an overview of a method to identify words in descriptions for categorized tasks that correspond to elements needed to facilitate performance of the task by an autonomous agent usable within a system 100 as carried out by a server computer 102 having optionally shared storage 104. The server computer 102 is in communication with a source (e.g., such as from a user interface, storage device, etc.) of task textual descriptions 106 and a task attribute database 108. It is noted that the task attribute database 108 is preferably a lexical database, such as the database operated by the International Computer Science Institute and which is in this field as “FrameNet,” although other similar lexical databases selected according to the judgment of one skilled in this field could suffice.

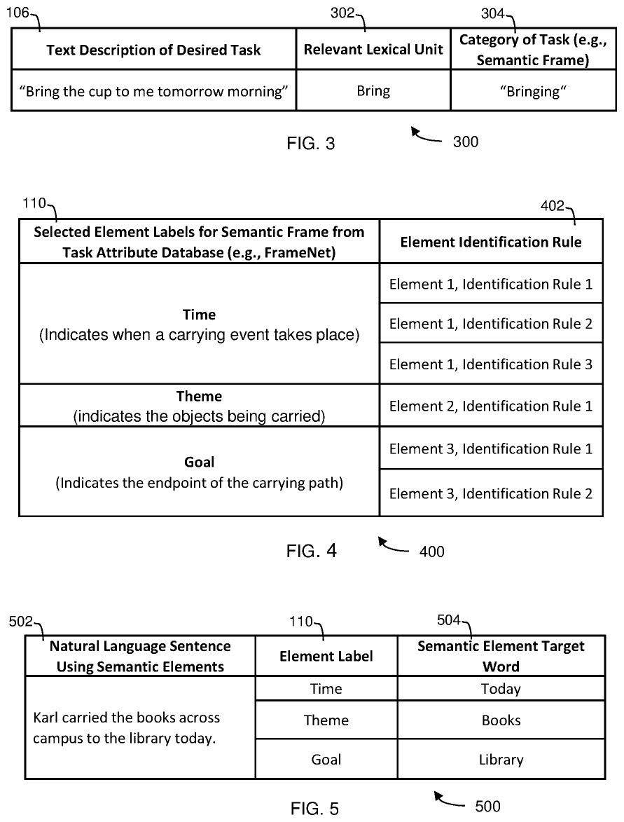

According to aspects of the invention, the task described belongs to one of several known categories identified in the task attribute database 108 as a semantic frame. The semantic frame 304 (e.g., as shown in Table 300 in FIG. 3) provides context for the task description 106 and can be provided explicitly along with the task description, or it may be identified by key frame-indicating words (e.g., often known to those of skill in this field as “lexical units”) within the description. The task attribute database 108 includes information about a wide variety of semantic frames, and the sever computer 102 receives information associated with the semantic frame 304 for the described task, including a list of semantic element labels 110 that identify attributes of tasks in a given semantic frame, and relevant metadata 112 including at least one element identification rule 402 (e.g., shown in Table 400 of FIG. 4) that indicate how (e.g., via syntax, key words, etc.) element labels appear and function in task descriptions 106 and at least one reference sentence 502 (e.g., as shown in Table 500 of FIG. 5) showing natural language use of semantic elements 110 relevant for the described task 106. The server computer 102 includes a parser 114 that breaks the provided task description 106 into words 702, (organized, for example, into word groups, syntactic phrases, individual words or various combinations thereof, as selected in accordance with the judgment of one skilled in this field). The sever computer 102 includes a Rule Match Value Generator (RMVG) 116 that quantifies element identification rule 402 matches for the parsed words 702. The server computer 102 includes a Candidate Word Set Collector (CWSC) 118 that places words 702 having a rule matching value above a predetermined candidate match threshold, into sets of candidate words 802 associated with each of the semantic element labels 110. According to aspects of the invention, words 702 not identified as a candidate word 802 are removed from further analysis, thereby strategically reducing computation requirements in downstream processing. As used herein, the term “word” may represent a single word, character spans, word groups, and combinations thereof.

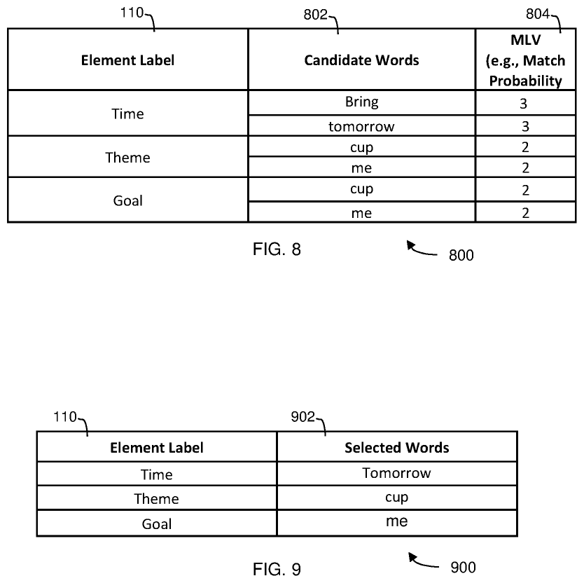

The server computer 102 includes a Match Likelihood Value Generator (MLVG) 120 that uses a neural network or similar ranking tool to determine at probability that candidate words 802 are the semantic elements 110 for which they have been identified as a possible candidate by the RMVG 116. The server computer 102 includes Representative Word Selector (RWS) 122 that chooses, from among the candidate words 802 for each semantic element 110, a word 902 having the highest likelihood of being the semantic element for which the word is a candidate. This selection can be made upon probabilities determined by the MLVG 120, or the selection may consider other factors, as well. For example, previously computed semantic element rule match values 704 for candidate words 802 may be multiplied by the associated match likelihood values 804, so that the overall match likelihood value for a given candidate word is, respective to each relevant semantic element, the product of those values. According to aspects of the invention, candidate words 802 are assigned to only one semantic element in a given task description 106, and the RWS 122 employs heuristic tests known by those skilled in this field to ensure the candidate words are selected for only one semantic element label 110. According to aspects of the invention, the selected words 902 (e.g., as shown in Table 900 in FIG. 9) are passed along to an autonomous agent 124 for completion of the described task 106.

Now with reference specifically to FIG. 2, and to other figures generally, a method to automatically identify words in descriptions for categorized tasks that correspond to elements needed to facilitate performance of the task by an autonomous agent using the system shown in FIG. 1 will be described. The server computer 102 receives, at block 202, a textual description of a categorized task 106. According to aspects of the invention, the description 106 is a natural language expression, such as a sentence, that includes activity details and conditions that must be met in order for successful completion of the task. As shown in Table 300 of FIG. 3, where an exemplary task description 106 is provided, the description may include a lexical unit 302 that indicates the semantic frame 304 to which the task belongs. For example, the exemplary task description 106, “Bring the cup to me tomorrow morning” includes the relevant lexical unit 302, “[b]ring,” which indicates the task belongs to a “Bringing” semantic frame 304 entry in the FrameNet lexical database.

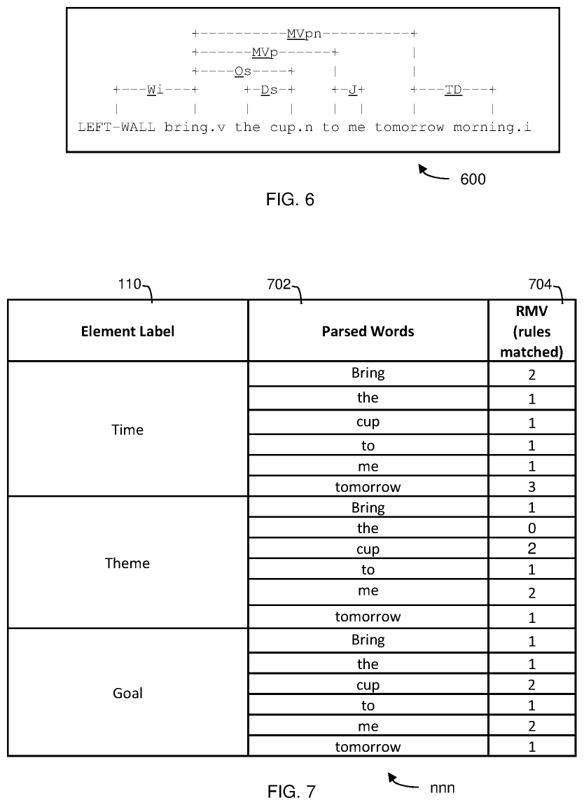

The server computer 102, receives from task attribute database 108 at block 204, semantic element labels 110 associated with aspects of the described task 106 and relevant Metadata 112. The exemplary semantic frame includes several semantic elements that correspond to various aspects of the described task 106, including “Time” (which indicates when a carrying event takes place), “Theme” (which indicates the object being carried), and “Goal” (which indicates the endpoint of the carrying path). The metadata 112 received includes element identification rules 402 (shown schematically in FIG. 4) for the semantic element labels 110 and at least one reference sentence 502 showing the semantic element labels used in natural language. According to aspects of the invention, the element identification rules may be based on syntactic patterns (e.g., phrase structure patterns and dependency relation patterns). According to aspects of the invention, the element identification rules may be relevant to constituency-based tree structures 600 (e.g., see FIG. 6). According to aspects of the invention, the element identification rules 404 may include target words 504, which if found within the task description, may indicate relevance to respective element labels 110. According to aspects of the invention other element identification rules 404 may also be used, however, it is not intended for an exhaustive of element identification rules to be provided. Embodiments of this invention identify words 902 from the task description 106 that may be used to carry out the task described. For example, the selected words 902 may be provided to an autonomous agent having various relevant capabilities (e.g., a helper robot, etc.) which can use the selected words to complete the described task 106. As autonomous agent capability scope increases, the tasks and associated element labels also increase. Generating a set of element identification rules 404 with enough detail to sufficiently address all possible natural language variations in task descriptions 106 and to cover an ever-increasing number of agent-relevant tasks and all associated semantic elements for an exhaustive rule-based task description analysis is resource prohibitive. However, according to aspects of the present invention, a set of element identification rules 404 received from task attribute database 108 is useful to identify candidate words 802 that are possible matches for the semantic elements associated with the category or semantic frame to which the task belongs. According to aspects of the invention, applying rules to select, from among all words in the provided task description, a subset of candidate words 802 for further processing with non-rule-based, processing-intensive AI assessment algorithms (such as those used, e.g., by MLVG 120 in block 212 described below) achieves gains in overall speed, while producing accurate results.

The server computer 102 extracts via parser 114 at block 206, a set of words 704 from the task description 106. According to aspects of the invention, the parser may represent the words 704 in a constituency tree 600 or other syntactically-based arrangement for syntax-based identification of element labels 110 downstream of block 206. The server computer 102 then, via RMVG 116 in block 208, determines for each semantic element label 110, a corresponding set of Rule Match Values (RMVs) 704 by applying the Element identification rules 404 for the element to each of the parsed words 702. According to aspects of the invention, RMVs 704 represents a number of element identification rules 404 matched (as defined by the rules or as otherwise defined by one skilled in this field) by a given word for all identification rules for a given element label.

The server computer 102 collects, via Candidate Word Set Collector (CWSC) 118 at block 210, words 702 having, for a given element label 110, an RMV 704 greater than a predetermined relevant value, such as a top N percent (e.g., a top 20%) of RMVs or a specific quantity (e.g., more than 1) selected as a candidate match threshold. For each semantic element label 110 Words with RMV 704 above the candidate match threshold are identified as candidate word 802 for that element label and placed into a set of candidate words associated with the element label. According to aspects of the invention, only words 702 that are candidate words 802 for a given element label are passed along for further processing. This generates an accurately-filtered subsets 802 of words from the task description 106 provided and reduces the processing needed to provide accurate element label word selection results in later, processing-intensive assessment (e.g., by MLVG 120 in block 212) compared to what would otherwise be necessary if applying processing-intensive ranking rules to each word 702 in the task description 106.

The server computer 102, via a ranking model Generate, for each candidate word, Match Likelihood Values (MLVs) indicating a probability that each candidate word 804 represents the semantic element labels 110 with which the candidate word has been associated by the CWSC 118. According to aspects of the invention, the ranking model is a neural network or similar classifier (e.g., a text classifier) trained on the provided reference sentences 502 received from the task attribute database 108. It is noted that the metadata 112 may also include sentences or word groups with character span annotation for the various included semantic elements (e.g., “begin=6”, “end=23”, “element=theme” for “paint the cyan cylinder in blue.”). Although not required, when such character span annotation is provided, the performance of the ranking model is improved. It is noted that MLVs are probability values that range, as is typical, from 0 to 1, with higher values indicating a higher probability that an associated ranked candidate word 804 is the correct choice for the semantic element with which the candidate is associated. In accordance with the judgment of one skilled in this field, and as noted above, the MLV can be this probability value, or it may be some compound value, such as the product of MLV and RMV for a given candidate word, with respect to each semantic element for which the word is a candidate.

The server computer 102, via representative word selector 122 at block 214, selects as words 902 that represent the semantic elements 110, candidate words 804 having the highest MLV for the elements with which they are associated. According to an embodiment, the server computer 102 presents, at block 216, the selected words 902 to an autonomous agent 124 for use in completing the described task 106.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

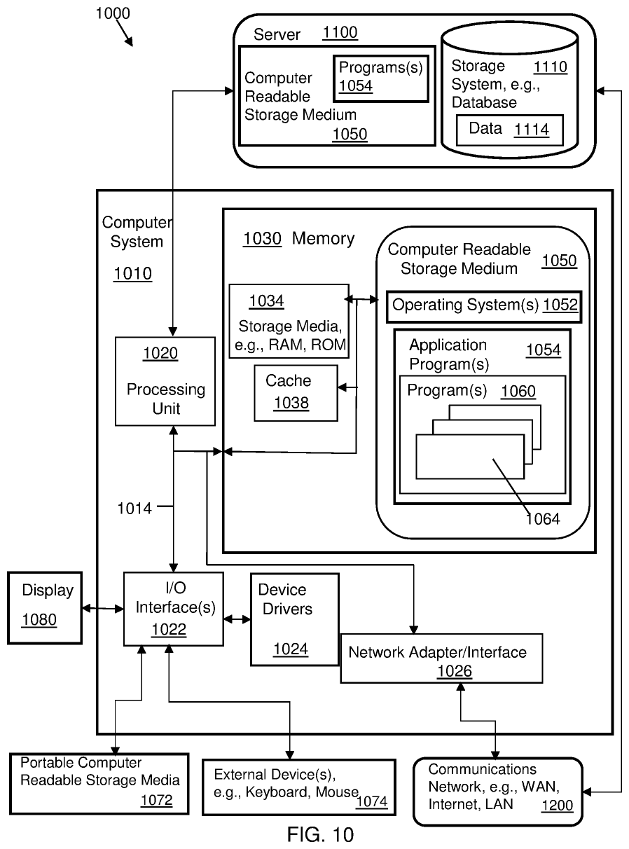

Referring to FIG. 10, a system or computer environment 1000 includes a computer diagram 1010 shown in the form of a generic computing device. The method 100, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that the control system 70 (shown in FIG. 10) can include all or part of the computer system 1010 and its components, and/or the control system can communicate with all or part of the computer system 1010 and its components as a remote computer system, to achieve the control system functions described in the present disclosure. It is also understood that the one or more communication devices 110 shown in FIG. 1 similarly can include all or part of the computer system 1010 and its components, and/or the communication devices can communicate with all or part of the computer system 1010 and its components as a remote computer system, to achieve the computer functions described in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

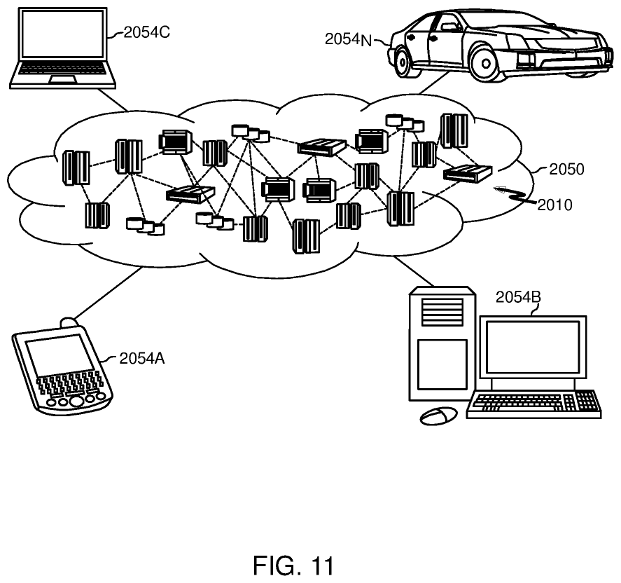

Referring now to FIG. 11, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 10 are intended to be illustrative only and that computing nodes 2010 and cloud computing environment 2050 can communicate with any type of computerized device over any type of network and/or network addressable connection (e.g., using a web browser).

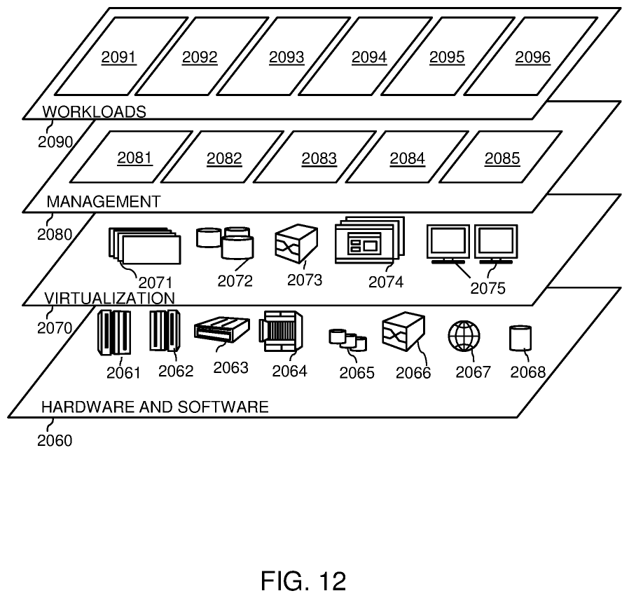

Referring now to FIG. 12, a set of functional abstraction layers provided by cloud computing environment 2050 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and identifying words in descriptions for categorized tasks that facilitate performance of the tasks by autonomous agents 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method to identify, within a description of a task, words that correspond to semantic element labels associated with aspects of the task, comprising:
receiving, by a computer, from a task source operatively connected therewith, a textual description of a task;
receiving, by said computer, from a task attribute database, at least one semantic element label associated with an aspect of the task, metadata including element identification rules associated with the at least one semantic element label, and at least one reference sentence showing the at least one semantic element label used in natural language;
parsing, by said computer with a word parser, said textual description to generate a list of words;
determining for the at least one semantic element label, a Rule Match Value (RMV) for each of said words based, at least in part, on applying the element identification rules for the at least one semantic element label to said words;
collecting, by said computer, for the at least one semantic element label, words having RMVs that exceed a predetermined candidate match threshold into sets of associated of candidate words;
generating, by said computer, for each candidate word, using a neural network trained on said at least one reference sentence, Match Likelihood Values (MLVs) indicating a probability that each candidate word represents the at least one semantic element label with which the candidate word is associated; and
selecting as the word that represents the at least one semantic element, the associated candidate word having a highest MLV.

2. The method of claim 1, wherein said task attribute database is lexical database.

3. The method of claim 1, wherein said metadata includes at least one target word associated with said semantic element; and wherein said at least one description rule is based at least in part on said at least one key word.

4. The method of claim 1, wherein said parsing generates a constituency-based tree from said description; and wherein said element identification rules are constituency tree-based.

5. The method of claim 4, wherein said parsing generates syntactic patterns selected from a list consisting of phrase structure patterns and dependency relation patterns; and wherein said element identification rules are based at least in part on said syntactic patterns.

6. The method of claim 1, wherein said at least one reference sentence further includes character span annotation for the at least one semantic element.

7. The method of claim 1, wherein said generation of said MLVs includes generating an n-dimensional vector using a transformer based encoder and scoring said n-dimensional vector using said neural network.

8. The method of claim 1, wherein said neural network is a text classifier.

9. A system to identify, within a description of a task, words that correspond to semantic element labels associated with aspects of the task, which comprises:
a computer system comprising a computer readable storage medium having program instructions embodied therewith, the program instructions executable by a computer to cause the computer to:
receive, from a task source operatively connected with the computer, a textual description of a task;
receive, from a task attribute database, at least one semantic element label associated with an aspect of the task, metadata including element identification rules associated with the at least one semantic element label, and at least one reference sentence showing the at least one semantic element label used in natural language;
parse with a word parser, said textual description to generate a list of words;
determine for the at least one semantic element label, a Rule Match Value (RMV) for each of said words based, at least in part, on applying the element identification rules for the at least one semantic element label to said words;
collect, by said computer, for the at least one semantic element label, words having RMVs that exceed a predetermined candidate match threshold into sets of associated of candidate words;
generate, by said computer, for each candidate word, using a neural network trained on said at least one reference sentence, Match Likelihood Values (MLVs) indicating a probability that each candidate word represents the at least one semantic element label with which the candidate word is associated; and
select as the word that represents the at least one semantic element, the associated candidate word having a highest MLV.

10. The system of claim 9, wherein said task attribute database is lexical database.

11. The system of claim 9, wherein said metadata includes at least one target word associated with said semantic element; and wherein said at least one description rule is based at least in part on said at least one key word.

12. The system of claim 9, wherein said parsing generates a constituency-based tree from said description; and wherein said element identification rules are constituency tree-based.

13. The system of claim 12, wherein said parsing generates syntactic patterns selected from a list consisting of phrase structure patterns and dependency relation patterns; and wherein said element identification rules are based at least in part on said syntactic patterns.

14. The system of claim 9, wherein said at least one reference sentence further includes character span annotation for the at least one semantic element.

15. The system of claim 9, wherein said generation of said MLVs includes generating an n-dimensional vector using a transformer based encoder and scoring said n-dimensional vector using said neural network.

16. The system of claim 9, wherein said neural network is a text classifier.

17. A computer program product to identify, within a description of a task, words that correspond to semantic element labels associated with aspects of the task, the computer program product comprising a computer readable storage medium having program instructions embodied therewith, the program instructions executable by a computer to cause the computer to:
receive, using said computer, from a task source operatively connected with said computer, a textual description of a task;
receive, using said computer, from a task attribute database, at least one semantic element label associated with an aspect of the task, metadata including element identification rules associated with the at least one semantic element label, and at least one reference sentence showing the at least one semantic element label used in natural language;
parse, using said computer, with a word parser, said textual description to generate a list of words;
determine, using said computer, for the at least one semantic element label, a Rule Match Value (RMV) for each of said words based, at least in part, on applying the element identification rules for the at least one semantic element label to said words;
collect, using said computer, for the at least one semantic element label, words having RMVs that exceed a predetermined candidate match threshold into sets of associated of candidate words;
generate, for each candidate word, using a neural network trained on said at least one reference sentence, Match Likelihood Values (MLVs) indicating a probability that each candidate word represents the at least one semantic element label with which the candidate word is associated; and
select, using said computer, as the word that represents the at least one semantic element, the associated candidate word having a highest MLV.

18. The computer program product of claim 17, wherein said metadata includes at least one target word associated with said semantic element; and wherein said at least one description rule is based at least in part on said at least one key word.

19. The computer program product of claim 17, wherein said parsing generates a constituency-based tree from said description; and wherein said element identification rules are constituency tree-based.

20. The computer program product of claim 17, wherein said generation of said MLVs includes generating an n-dimensional vector using a transformer based encoder and scoring said n-dimensional vector using said neural network.
